(19) United States
(12) Patent Application Publication
(10) Pub. No.: US 2020/0383179 A1
(43) Pub. Date: Dec. 3, 2020

(54) SYSTEM, COMPUTER-READABLE STORAGE MEDIUM, AND METHOD

(71) Applicant: SoftBank Group Corp., Tokyo (JP)

(72) Inventor: Masayoshi SON, Tokyo (JP)

(21) Appl. No.: 16/726,265

(22) Filed: Dec. 24, 2019

(30) Foreign Application Priority Data
May 31, 2019 (JP) 2019-103221

(51) Int. Cl. H05B 6/06; G01C 21/34; G01C 21/36; F24C 7/10; H05B 1/02

(52) U.S. Cl. CPC H05B 6/062; G01C 21/343; H05B 1/0261; G01C 21/3605; F24C 7/10; G01C 21/3492

(57) ABSTRACT

The system controls a heating cooker that cooks the food by heating the food. The system includes an acquiring unit that acquires an estimated time of arrival at a delivery destination of the food during a delivery of the food and a control unit that controls the heating cooker based on the estimated time of arrival. A method performed by a computer comprises: acquiring an estimated time of arrival at a delivery destination of the food during a delivery of the food and controlling a heating cooker that cooks the food by heating the food based on the estimated time of arrival.

The contents of the following Japanese patent application are incorporated herein by reference:

Japanese patent application NO. 2019-103221 filed on May 31, 2019.

### BACKGROUND

### 1. Technical Field

The present invention relates to a system, a computer-readable storage medium, and a method.

### 2. Related Art

It is known a lunch delivery system allowing a transporting automobile loaded with a temperature refrigerator thereof delivering a meal to each home (see, for example, Patent Document 1). It is known a collection and delivery vehicle loaded with a constant temperature storage for keeping a temperature of a food to be a predetermined temperature (see, for example, Patent Document 2).

### Patent Document 1: Japanese Patent Application Publication No. 2003-259921

### Patent Document 2: Japanese Patent Application Publication No. 2002-178823

In a system for delivering a cooked food to a customer, it is desired that the food is in a freshly cooked state at the time of delivery.

### BRIEF DESCRIPTION OF THE DRAWINGS

FIG. 1 schematically illustrates one example of a usage in a system 10.

FIG. 2 schematically illustrates a whole structure of a cooking device 40.

FIG. 3 schematically illustrates a functional configuration of a cooking device 40.

FIG. 4 illustrates a data structure of cooking information stored in a storage unit 360.

FIG. 5 illustrates a data structure of delivery food information stored in a storage unit 360.

FIG. 6 illustrates one example of a relationship between a cooking time period of foods 44 and delivery timing.

FIG. 7 illustrates another example of a relationship between a cooking time period of foods 44 and delivery timing.

FIG. 8 schematically illustrates one example of a flow of processes by a control device 200.

FIG. 9 schematically illustrates a usage form in a system 900 as a modified example of a system 10.

FIG. 10 illustrates a functional configuration of a cooking device 940 used in a system 900.

FIG. 11 schematically illustrates a food container 1100 having a heating and cooking function together with a heater 1150.

FIG. 12 schematically illustrates one example of a hardware configuration of a computer 1200 functioning as a control device 200 or a server 902.

### DESCRIPTION OF EXEMPLARY EMBODIMENTS

Hereinafter, the present invention will be described with reference to embodiments of the invention. However, the following embodiments should not to be construed as limiting the claimed invention. Moreover, all the features of the combinations described in the embodiments are not necessarily essential as means for solving the problems of the invention.

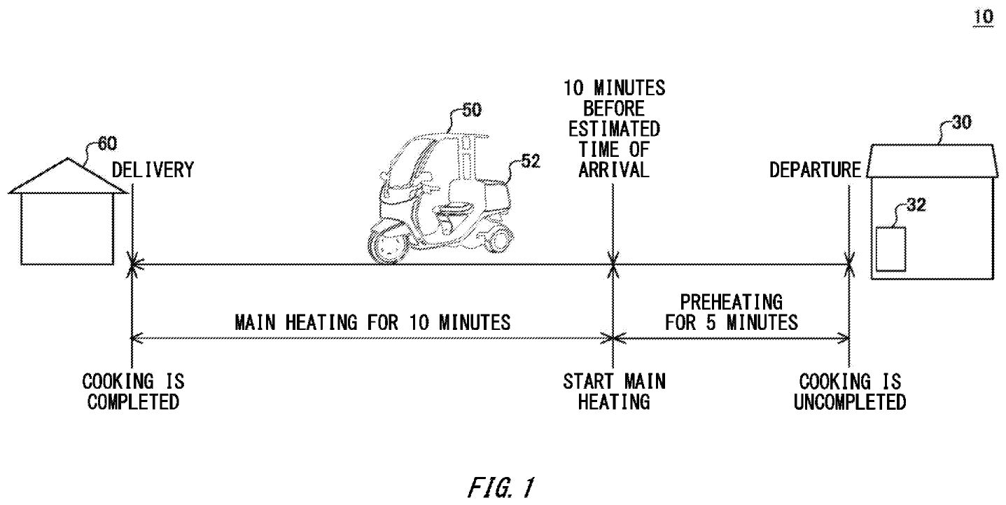

FIG. 1 schematically illustrates one example of a usage form in a system 10. The system 10 according to the present embodiment is for delivering a cooked food to a customer that is a delivery destination 60. Specifically, the system 10 is for delivering a food that is close to a freshly cooked state to the delivery destination 60.

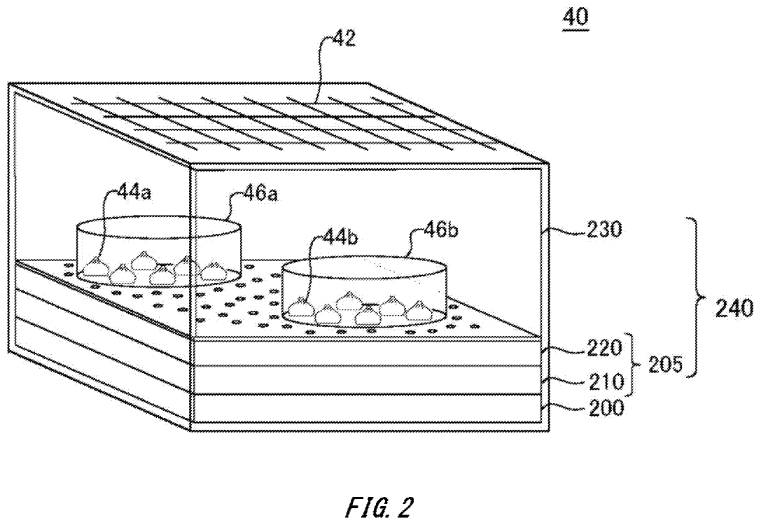

The system 10 includes a transport vehicle 50. The transport vehicle 50 includes a delivery box 52. A cooking device 40 illustrated in FIG. 2 is provided in the delivery box 52. FIG. 2 schematically illustrates a whole structure of a cooking device 40. As illustrated in FIG. 2, the cooking device 40 includes a heating cooker 240 and a control device 200. The cooking device 40 contains a food 44a and a food 44b. The food 44a and the food 44b may be collectively referred to as “foods 44.” During the delivery of the foods 44, the cooking device 40 cooks the foods 44 by heating them. A detailed configuration of the cooking device 40 will be described later.

Heating the foods 44 may include steaming the foods 44. The foods 44 may be Chinese steamed buns such as a soup dumpling, Chinese dumplings, a steamed bun with minced pork filling, and a dumpling with minced pork and vegetable stuffing for example. The present embodiment describes a form of steaming the foods 44 mainly with water vapor.

The foods 44 are cooked in a retail store 30 to some extent, and then contained in the cooking device 40, and thereafter, loaded on the transport vehicle 50. At the time when the transport vehicle 50 leaves for the delivery, cooking of the foods 44 is not completed yet.

It is assumed that, for example, the foods 44 require 10 minutes preheating and 10 minutes main heating. It is assumed that time required for the transport vehicle 50 to arrive at the delivery destination 60 from the retail store 30 is predicted to be 15 minutes. In this case, the foods 44 are contained in the cooking device 40 after being subjected to five minutes preheating in a kitchen of the retail store 30. A control device 200 in a cooking device 40 receives, from a retail store server 32, information indicating a position of a delivery destination 60 and types and cooking states of foods 44. For example, a control device 200 receives information indicating a state of having being subjected to five minutes preheating as a cooking state. A control device 200 drives a heating cooker 240 based on types and cooking states of foods 44 and continues the preheating of the food 44.

After a cooking device 40 is provided in a delivery box 52 of a transport vehicle 50, the transport vehicle 50 leaves the retail store 30. Even after a transport vehicle 50 leaves the retail store 30, a control device 200 continues preheating foods 44 with a heating cooker 240. A control device 200 calculates an estimated time of arrival at a delivery destination 60 based on a current position of a cooking device 40 and a position of a delivery destination 60. When it is 10 minutes before an estimated time of arrival of a delivery destination 60, a control device 200 causes a heating cooker 240 to start main heating foods 44. This allows completing cooking of foods 44 when a transport vehicle 50 arrives at a delivery destination 60. As described above, according to a system 10, foods that have been cooked 44 can be delivered to a delivery destination 60.

As illustrated in FIG. 2, a heating cooker 240 includes a heating apparatus 205 and a cooking device 230. The heating apparatus 205 includes a heat generating device 210 and a vapor generating device 220. The heating cooker 240 cooks foods 44 by heating it. Specifically, a heating cooker 240 cooks foods 44 by heating it with water vapor.

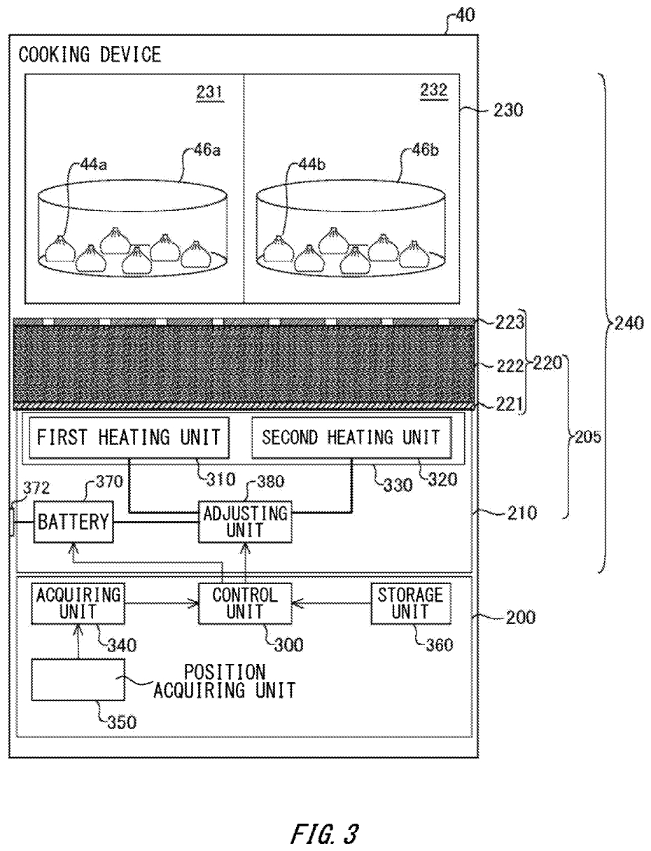

FIG. 3 schematically illustrates a functional configuration of a cooking device 40. A heat generating device 210 includes a battery 370, an adjusting unit 380, and a heating element 330.

A cooking device 40 is provided with a power cable connection port 372. A battery 370 is charged with power supplied from a power cable inserted into a power cable connection port 372. A battery 370 may be charged in the retail store 30. During delivery by a transport vehicle 50, a battery 370 may be charged with power supplied from the transport vehicle 50.

The heating element 330 consumes power supplied from the battery 370 and heats the vapor generating device 220. The heating element 330 includes a first heating unit 310 and a second heating unit 320. The first heating unit 310 and the second heating unit 320 are, for example, electric heaters.

The power supplied from the battery 370 may be supplied to the first heating unit 310 and the second heating unit 320 through the adjusting unit 380. The adjusting unit 380 switches a state of power supplied from the battery 370 to the first heating unit 310 and the second heating unit 320. Specifically, the adjusting unit 380 independently adjusts power supplied to the first heating unit 310 and power supplied to the second heating unit 320.

The vapor generating device 220 includes a heat transfer unit 221 in contact with a heating element 330, a water retaining body 222, and a vapor transmission plate 223. The water retaining body 222 is provided between the heat transfer unit 221 and the vapor transmission plate 223. The water retaining body 222 is a porous member. The water retaining body 222 retains water in many holes. The water retaining body 222 may be a sponge-like member, for example. The water retaining body 222 is heated with the heat supplied from the heating element 330. Water retained by the water retaining body 222 becomes a gas by the heat supplied from the heating element 330. This causes the water retaining body 222 to generate the water vapor. The water vapor generated from the water retaining body 222 flows into the cooking device 230 through many vertical holes of the vapor transmission plate 223.

The cooking device 230 contains a food 44. The cooking device 230 heats a food 44 with the water vapor from the water retaining body 222. Specifically, the food container 46a and the food container 46b that contain foods 44 are mounted in the cooking device 230. Examples of the food container 46a and the food container 46b include a steamer. The food container 46a and the food container 46b are taken out from the cooking device 40 after the transport vehicle 50 arrives at the delivery destination 60 and provided to a customer at a delivery destination 60.

As illustrated in FIG. 2, gaps 42 communicating with the outside are formed to an upper part of the cooking device 230. Vapors accumulated in the cooking device 230 are gradually discharged to the outside through the gaps 42.

The cooking device 230 includes a first region 231 and a second region 232. The first region 231 and the second region 232 are separated from each other. The first region 231 is heated by the first heating unit 310. The second region 232 is heated by the second heating unit 320.

For example, when the first heating unit 310 is energized, water retained in a region of the water retaining body 222 near the first heating unit 310 becomes water vapor due to the heat generated by the first heating unit 310 and mainly flows into the first region 231. This allows heating a food 44 in the first region 231 with the water vapor.

On the other hand, when the second heating unit 320 is energized, water retained in a region of the water retaining body 222 near the second heating unit 320 becomes the water vapor by the heat generated by the second heating unit 320 and mainly flows into the second region 232. This allows heating a food 44 in the second region 232 with the water vapor. This allows substantially continuing heating and cooking of foods 44 in the first region 231 and foods 44 in the second region 232 independently.

The control device 200 includes a control unit 300, an acquiring unit 340, a position acquiring unit 350, and a storage unit 360.

The storage unit 360 includes a nonvolatile storage medium and/or a volatile storage medium. The control device 200 performs processes by using information stored in the storage unit 360. Information stored in the storage unit 360 includes an operating system (OS), a communication control software, an application software running on the OS, and the like. The position acquiring unit 350 may be a positioning sensor such as a GPS sensor. The control unit 300 and the acquiring unit 340 may be realized by one or more ICs including an arithmetic processing device such as a processor. The control device 200 may be realized by a computer.

During the delivery of foods 44, the acquiring unit 340 acquires an estimated time of arrival at a delivery destination of the foods 44. The control unit 300 controls the heating cooker 240 based on an estimated time of arrival. For example, the control unit 300 determines a timing at which the heating cooker 240 heats foods 44 based on an estimated time of arrival. For example, the control unit 300 controls a timing at which the heating cooker 240 starts heating foods 44 based on an estimated time of arrival. Specifically, the control unit 300 starts heating by the heating cooker 240 when time between an estimated time of arrival and a current time is shorter than predetermined time.

The control unit 300 controls the heating cooker 240 based on types of foods 44. For example, the storage unit 360 stores information indicating the heating time in association with types of foods 44. The control unit 300 controls a timing at which the heating cooker 240 heats foods 44 based on the heating time associated with types of foods 44 stored in the storage unit 360 and an estimated time of arrival. Specifically, the control unit 300 determines a timing at which the heating cooker 240 heats foods 44 based on the heating time associated with types of foods 44, an estimated time of arrival, and a current time.

The control unit 300 may adjust the heating intensity of foods 44 by the heating cooker 240 based on an estimated time of arrival. The control unit 300 adjusts the heating intensity of foods 44 by the heating cooker 240 based on types of foods 44. For example, the storage unit 360 stores heating intensity information indicating the time change of the heating intensity until cooking of foods 44 is completed in association with types of the foods 44. The control unit 300 controls a timing at which the heating cooker 240 heats foods 44 according to heating intensity information based on an estimated time of arrival and a current time.

The control unit 300 may acquire estimated times of arrival at a plurality of timings and adjust the heating intensity of foods 44 by the heating cooker 240 depending on a change in estimated times of arrival. If an arrival time at a delivery destination is predicted to be delayed from an estimated time of arrival after start heating foods 44 by the heating cooker 240 based on estimated time of arrival, for example, the control unit 300 may decrease the heating intensity of foods 44 by the heating cooker 240. Alternatively, if an arrival time at a delivery destination is predicted to be earlier than an estimated time of arrival after start heating foods 44 by the heating cooker 240 based on an estimated time of arrival, the control unit 300 may increase the heating intensity of foods 44 by the heating cooker 240.

The storage unit 360 stores the degree of cooking progress of foods 44 when leaving for delivery of foods 44. The control unit 300 may determine a timing at which the heating cooker 240 heats foods 44 based on the degree of progress and an estimated time of arrival. For example, as the degree of progress is lower, the control unit 300 may increase a time between an estimated time of arrival and a timing at which the heating cooker 240 heats foods 44.

The acquiring unit 340 may acquire a first estimated time of arrival when a first food 44 in a first region arrives at a delivery destination and a second estimated time of arrival when a second food 44 in a second region 232 arrives at a delivery destination. In this case, the control unit 300 may control a first heating unit 310 based on a first estimated time of arrival and control a second heating unit 320 based on a second estimated time of arrival. The control unit 300 controls the heating cooker 240 by controlling a power amount to a heating element 330. Specifically, the control unit 300 controls the amount of heat generated by each of the first heating unit 310 and the second heating unit 320 by controlling the adjusting unit 380.

As illustrated in FIG. 3 and the like, in one embodiment of a heating cooker 240, a heating apparatus 205 includes a heat generating device 210 and a vapor generating device 220. According to this form, foods 44 are cooked by being heated with the water vapor. For example, when one eats a soup dumpling, an important factor for enjoying a feature of a soup dumpling is to eat a soup dumpling that has been steamed by taking care not to burn oneself. A vapor generating device 220 includes a water retaining body 222 for retaining water, and thus, water is not splashed or spilled due to vibration during the delivery. According to the heating cooker 240 illustrated in FIG. 3 and the like, a final process of cooking a steamed dish such as a soup dumpling is performed during the delivery and the food can be provided to a customer in a freshly steamed state when arriving at a delivery destination.

On the other hand, there are, for example, foods that require a baking process as a cooking process such as a hamburg and a baked dumpling with minced pork and vegetable stuffing. To provide such food close to freshly cooked state to a customer, as another form of a heating apparatus 205 in a heating cooker 240, a configuration at least partially having a heat transfer member such as an iron plate may be adopted instead of a vapor generating device 220. As described above, the present invention is not limited to a form of cooking by water vapor heating such as steaming, and as a modified example of a heating cooker 240, adoptable is a configuration for cooking foods by baking, steaming, heating by electromagnetic waves such as far infrared rays or frying.

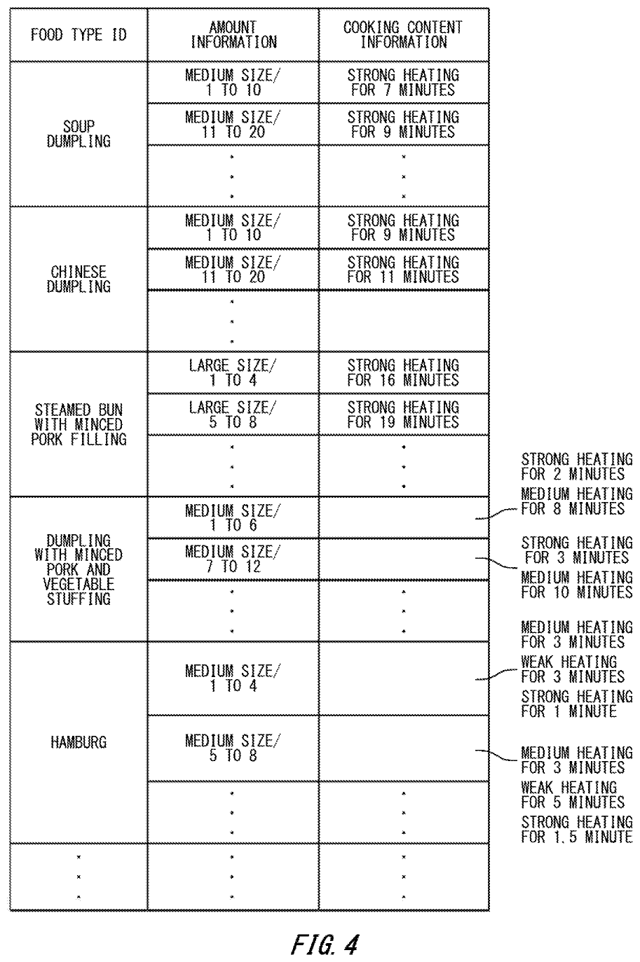

FIG. 4 illustrates a data structure of cooking information stored in a storage unit 360. In the cooking information, a food type ID, amount information, and cooking content information are associated with one another.

The food type ID is identification information indicating a type of a food to be cooked. The amount information is information indicating the amount of foods to be cooked. The amount information may be information indicating a combination of the number of foods to be cooked and sizes of foods. The cooking content information is information indicating cooking contents until cooking of foods to be cooked is completed. The cooking content information may be information indicating a combination of the heating time and the heating intensity.

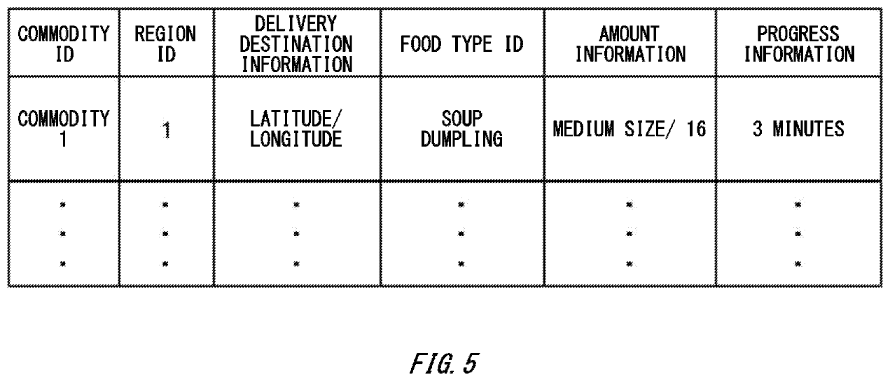

FIG. 5 illustrates a data structure of delivery food information stored in a storage unit 360. In the delivery food information, a commodity ID, a region ID, delivery destination information, a food type ID, amount information, and progress information are associated with one another.

The commodity ID is identification information of the commodity containing foods to be delivered. The region ID is identification information of a region where foods are provided in a cooking device 230. The region ID stores identification information of either one of the first region 231 and the second region 232. The region ID indicates which of the first region 231 and the second region 232 contains foods. The delivery destination information indicates a position of a delivery destination of the commodity. The delivery destination information may be latitude information and longitude information indicating a geographical position of a delivery destination.

The food type ID is identification information indicating types of foods to be cooked. The amount information is information indicating the amount of foods to be cooked. The amount information indicates a combination of the number of foods and sizes of foods contained in a commodity.

The progress information indicates the degree of cooking progress when leaving for the delivery. Specifically, the progress information indicates the degree of progress of cooking at the retail store 30. For example, when a soup dumpling is heated for three minutes in the retail store 30, the progress information stores “three minutes” that is a time during which heating is performed in the retail store 30.

The control device 200 receives delivery food information from a retail store server 32 and stores the information in a storage unit 360. The control unit 300 refers to the delivery food information and the cooking information stored in the storage unit 360, and controls the heating cooker 240 during the delivery of foods 44.

Specifically, the control unit 300 refers to the cooking information stored in the storage unit 360 and identifies cooking contents until cooking of foods 44 is completed. For example, when foods 44 as commodities are 16 medium-sized soup dumplings, the control unit 300 determines that cooking is completed after applying strong heating of nine minutes. The control unit 300 refers to the progress information stored in the storage unit 360 and determines that foods 44 are strongly heated for three minutes. Therefore, the control unit 300 determines to start strong heating by the heating cooker 240 six minutes before an estimated time of arrival at a delivery destination.

The control unit 300 determines that foods 44 are contained in a first region 231 based on a region ID included in delivery food information. Therefore, the control unit 300 cooks foods 44 during the delivery of the foods 44 by controlling a first heating unit 310 based on delivery destination information, progress information, and cooking content information of foods 44, a current time, and a current position of a cooking device 40.

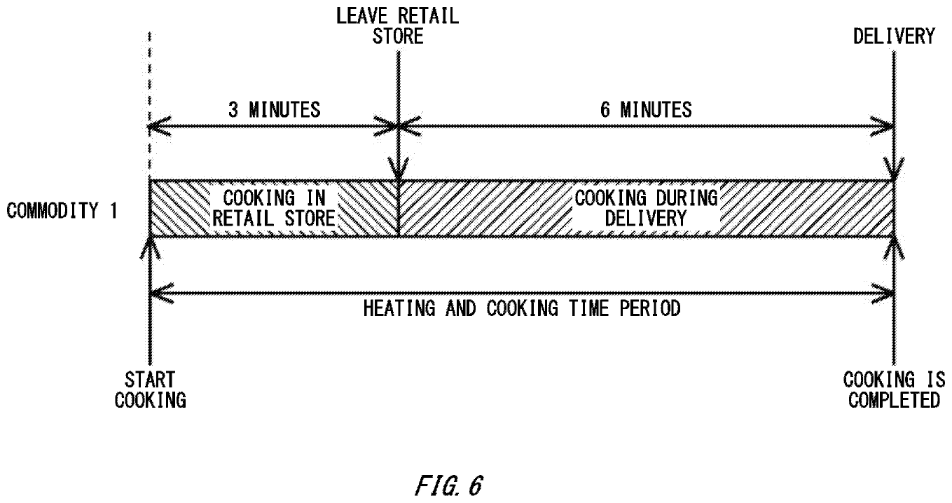

FIG. 6 illustrates one example of a relationship between a cooking time period of foods 44 and delivery timing A retail store server 32 determines a cooking schedule for foods 44 based on order information from a customer.

For example, a retail store server 32 identifies a time required for a transport vehicle 50 to travel from the retail store 30 to a delivery destination 60 based on a position of the delivery destination included in order information and traffic information. A retail store server 32 determines a cooking schedule for foods 44 that are commodities based on cooking information stored in a storage unit 360 and a required time.

For example, if foods 44 as commodities are 16 medium-sized soup dumplings, a retail store server 32 determines that cooking is completed after applying strong heating of nine minutes. When a time required for moving from the retail store 30 to a delivery destination 60 is six minutes, a retail store server 32 determines to apply strong heating for three minutes in the retail store 30 and apply strong heating for six minutes during the delivery. A retail store server 32 determines which of a first region 231 and a second region 232 in a cooking device 230 of a heating cooker 240 contains foods 44.

A retail store server 32 generates delivery food information and transmits the information to a control device 200. The control device 200 stores the delivery food information received from the retail store server 32 in a storage unit 360. After heating foods 44 strongly for three minutes in a kitchen of the retail store 30, a cooking device 40 containing foods 44 subjected to strong heating for three minutes is loaded on a delivery box 52 of a transport vehicle 50. After a transport vehicle 50 leaves a retail store, the control unit 300 refers to delivery food information and cooking information stored in a storage unit 360 and continues cooking of foods 44 during the delivery of foods 44 by controlling a heating cooker 240.

In an example described above, while strong heating for nine minutes is required to complete foods 44 cooking, the foods 44 are strongly heated for three minutes in the retail store 30, and thus, a required remaining heating time is six minutes. On the other hand, a time required for moving from the retail store 30 to a delivery destination 60 is also six minutes. In this case, when a transport vehicle 50 leaves a store, the control unit 300 controls a power amount of a first heating unit 310 and starts heating foods 44 strongly.

An acquiring unit 340 sequentially acquires estimated times of arrival based on a current position acquired from a position acquiring unit 350 and positional information of a delivery destination included in delivery destination information. The control unit 300 adjusts the heating intensity of foods 44 depending on a change in estimated times of arrival. For example, if an estimated time of arrival is delayed by four minutes from a current time at a time point when three minutes have been elapsed after leaving the retail store 30, the control unit 300 decreases a power amount of a first heating unit 310 and decreases the heating intensity of foods 44. On the other hand, if an estimated time of arrival is shortened to two minutes from a current time at a time point when three minutes have been elapsed after leaving the retail store 30, the control unit 300 increases a power amount of a first heating unit 310 and increases the heating intensity of foods 44.

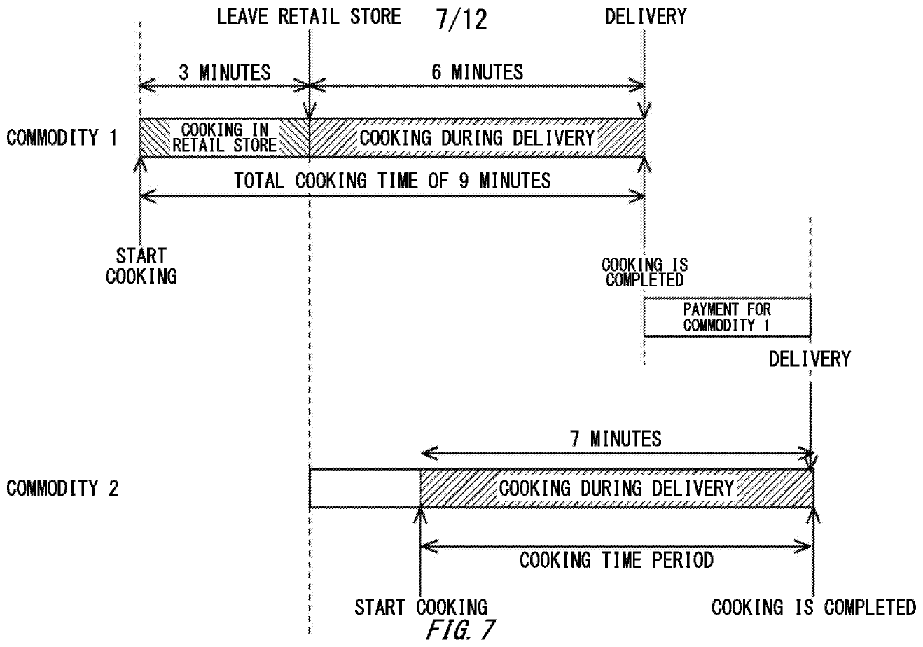

FIG. 7 illustrates another example of a relationship between a cooking time period of foods 44 and a delivery timing FIG. 7 illustrates the same operation during a time period until the delivery of a commodity 1 is completed as FIG. 6. FIG. 7 illustrates, as an example, a case where a commodity 2 is ordered immediately before a transport vehicle 50 leaves a retail store after a commodity 1 is ordered. A commodity 2 is assumed to be ten medium-sized soup dumplings. A delivery destination of a commodity 2 is assumed to be close to a delivery destination of a commodity 1. It is assumed, for example, a delivery destination of a commodity 1 is one room of a condominium building and a delivery destination of a commodity 2 is another room of the same condominium building.

A retail store server 32 predicts that seven minutes are required to complete the cooking of a commodity 2. It is assumed that only one transport vehicle 50 is currently available. In this case, if a commodity 2 is delivered after a transport vehicle 50 finish delivering a commodity 1 and returning to the retail store 30, 18 minutes or more are required to deliver the commodity 2. On the other hand, when the transport vehicle 50 delivering the commodity 1, a retail store server 32 determines that an estimated time of arrival of the commodity 2 at a delivery destination is nine minutes later after leaving the retail store 30 if both a commodity 1 and a commodity 2 are transported with a transport vehicle 50. The retail store server 32 determines an estimated time of arrival of a commodity 2 by considering a fee payment time after delivering a commodity 1 and a time required to travel from a delivery destination of the commodity 1 to a delivery destination of the commodity 2.

The retail store server 32 determines to transport both a commodity 1 and a commodity 2 with a transport vehicle 50 when delivering the commodity 1 with the transport vehicle 50. Specifically, the retail store server 32 places a commodity 1 in a first region 231 of a cooking device 230 and places a commodity 2 in a second region 232 of the cooking device 230 so as to generate a cooking schedule such that cooking of a food of the commodity 2 is started during the delivery of the commodity 2.

Specifically, the retail store server 32 generates delivery food information of a commodity 2 and transmits the information to a control device 200. As one example, delivery food information of a commodity 2 includes “2” indicating a second region 232 as a region ID, “a soup dumpling” as a food type ID, “ten small-sized” as amount information and “zero minute” as progress information.

The control device 200 stores, in a storage unit 360, delivery food information of a commodity 2 received from a retail store server 32. The control unit 300 refers to delivery food information and cooking information stored in the storage unit 360 and controls a heating cooker 240 during the delivery of a commodity 2. Specifically, a time required to cook a food of a commodity 2 is seven minutes, and thus, the control unit 300 starts heating the food of the commodity 2 at a timing seven minutes before an estimated time of arrival of the commodity 2 to a delivery destination. For example, the control unit 300 controls a power amount of a second heating unit 320 and start strongly heating the food of the commodity 2. As described above, the heating cooker 240 allows cooking a commodity 1 and a commodity 2 separately and independently. Therefore, while the system can provide a food that is close to a freshly cooked state, the system can prevent a waiting time of a customer from being long even a small number of transport vehicles 50 are used.

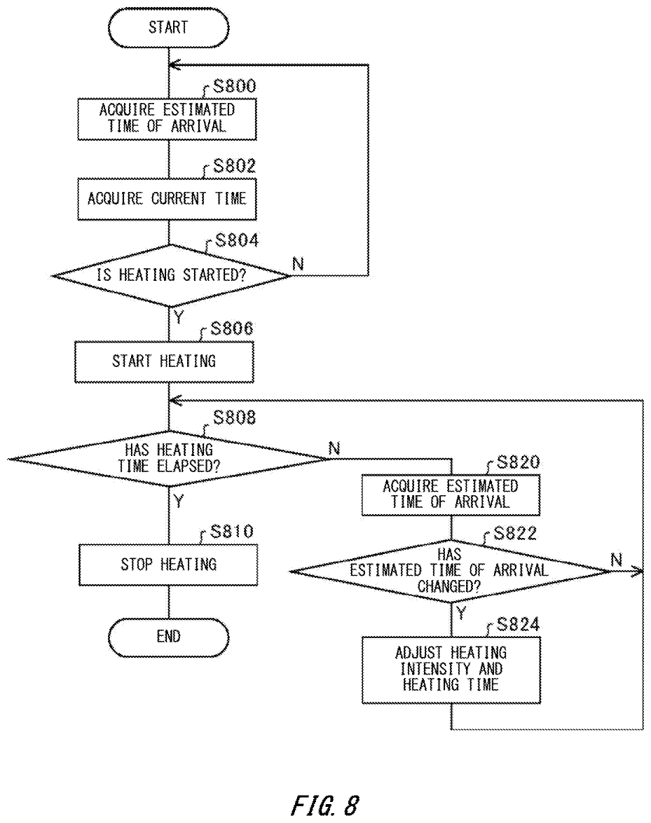

FIG. 8 schematically illustrates one example of a flow of processes by a control device 200. The processes in FIG. 8 are started when foods 44 are placed in a cooking device 230 of a heating cooker 240.

In step (step may be abbreviated as S) 800, an acquiring unit 340 acquires an estimated time of arrival. For example, an acquiring unit 340 acquires an estimated time of arrival at a delivery destination based on delivery destination information in delivery food information stored in a storage unit 360 and current position information acquired by a position acquiring unit 350. The acquiring unit 340 may acquire an estimated time of arrival at a delivery destination from an external traffic route information server by making an inquiry to the external traffic route information server.

In S802, the control unit 300 acquires a current time. In S804, the control unit 300 determines whether a current time is a timing for starting heating. For example, the control unit 300 refers to cooking information and delivery food information and determines whether a difference between a time required for arriving at a delivery destination and a remaining cooking time is less than a predetermined threshold. A time required for arriving at a delivery destination is represented by a difference between an estimated time of arrival and a current time. A remaining cooking time is represented by a time in which a heating time indicated by progress information is subtracted from a heating time identified from cooking content information. If a difference between a time required for arriving at a delivery destination and a remaining heating time is a threshold or more, the process returns to S800. If a difference between a time required for arriving at a delivery destination and a remaining heating time is less than a threshold, in S806, the control unit 300 starts heating foods 44. For example, if foods 44 are placed in a first region 231, the control unit 300 starts energizing a first heating unit 310. The control unit 300 adjusts a current heating intensity based on cooking content information included in cooking information.

In S808, the control unit 300 determines whether a heating time has elapsed. If a heating time has elapsed, in S810, the control unit 300 stops heating foods 44. If the control unit 300 determines that a heating time has not elapsed in S808, in S820, an acquiring unit 340 acquires an estimated time of arrival. In S822, the control unit 300 determines whether an estimated time of arrival has changed. The control unit 300 determines that an estimated time of arrival has changed if for example, a time difference between a previously acquired estimated time of arrival and an estimated time of arrival acquired in S820 exceeds a predetermined time difference. If an estimated time of arrival has not changed, the process is advanced to S808. If an estimated time of arrival has changed, in S824, the control unit 300 adjusts the heating intensity and a heating time and the process is advanced to S808.

For example, in S824, if a time difference in which an estimated time of arrival acquired in S820 is subtracted from a previously acquired estimated time of arrival is −one minute, the control unit 300 decreases the heating intensity and increases a cooking time by one minute. If a time difference in which an estimated time of arrival acquired in S820 is subtracted from a previously acquired estimated time of arrival is +one minute, the control unit 300 increases the heating intensity and decreases a cooking time by one minute. This allows the control unit 300 adjusting the heating intensity and a heating time depending on the amount of change in an estimated time of arrival.

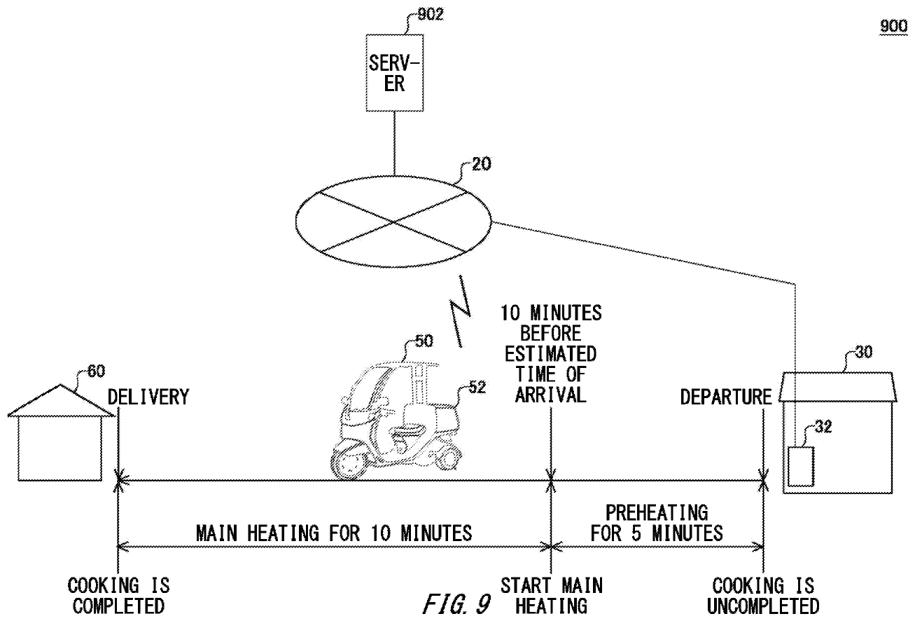

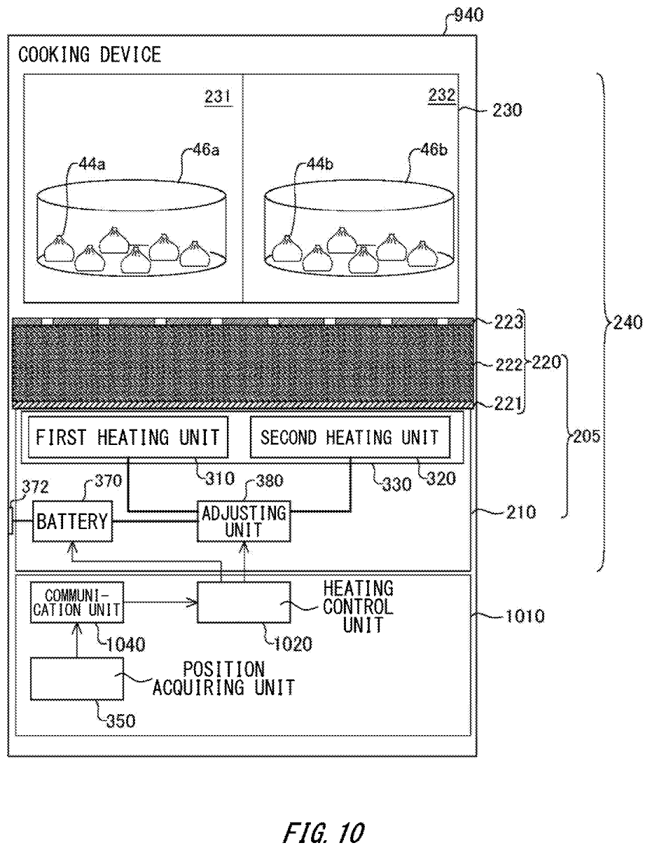

FIG. 9 schematically illustrates a usage form in a system 900 as a modified example of a system 10. FIG. 10 illustrates a functional configuration of a cooking device 940 used in the system 900. The system 900 includes a retail store server 32, a server 902, and the cooking device 940. The cooking device 940 includes a heating cooker 240 and a control device 1010. The control device 1010 includes a heating control unit 1020, a communication unit 1040, and a position acquiring unit 350.

In the system 900, the server 902 has functions of a control unit 300, an acquiring unit 340, and a storage unit 360 included in the control device 200 in the system 10. Except mainly for the above point, the system 900 has substantially the same functions and configurations as in the system 10.

The communication unit 1040 of the control device 1010 is responsible for the communication with the server 902. The communication unit 1040 transmits, to the server 902, current position information indicating a current position acquired by a position acquiring unit 350.

The communication unit 1040 and the server 902 communicate via a network 20. The network 20 may include a mobile communication network and the Internet. The mobile communication network may conform to any of a 3G (3rd Generation) communication system, an LTE (Long Term Evolution) communication system, a 5G (5th Generation) communication system, a 6G (6th Generation) communication system and subsequent communication systems. A user terminal 82 may access a mobile communication network via a wireless base station and may access a mobile communication network via a WiFi (registered trademark).

The server 902 receives, from the retail store server 32, delivery food information. The server 902 acquires an estimated time of arrival of a transport vehicle 50 based on positional information of a delivery destination included in delivery food information and current position information transmitted from the control device 1010. The server 902 generates control information for controlling the heating cooker 240 based on an estimated time of arrival and transmits the information to the control device 1010. In the control device 1010, the communication unit 1040 controls a heat generating device 210 based on control information received from the server 902. This allows providing foods 44 that are close to a freshly cooked state to a customer at the time of delivery.

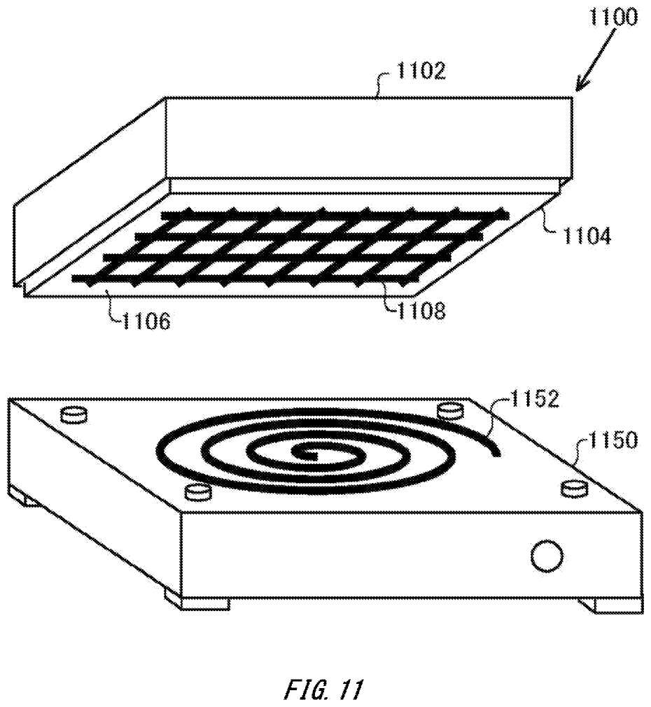

FIG. 11 schematically illustrates a food container 1100 having a heating and cooking function together with a heater 1150. The food container 1100 is loaded on a transport vehicle 50 to be delivered to a delivery destination. A food container 1100 is loaded on a delivery box 52 of a transport vehicle 50 and delivered to a delivery destination 60 by the transport vehicle 50. The food container 1100 may be loaded on the delivery box 52 of the transport vehicle 50 together with a cooking device 40 in the above described system 10 and a cooking device 940 in the system 900.

The food container 1100 is, for example, a lunch box having a heating and cooking function. The food container 1100 includes a container body 1104 and a lid 1102. The container body 1104 contains foods. A metal section 1108 is provided on a bottom 1106 of the container body 1104.

In the retail store 30, a food container 1100 is placed on a heater 1150. The heater 1150 has a heater 1152 at the top thereof. The heater 1152 generates heat by using electricity, gas or the like as an energy source.

When the heater 1152 of the heater 1150 is energized by placing the food container 1100 on the heater 1150 such that the metal section 1108 of the container body 1104 faces the heater 1152, the metal section 1108 is heated by heat generated by the heater 1152. The metal section 1108 accumulates heat from the heater 1152. As described above, before loading a food container 1100 on a transport vehicle 50, a container body 1104 in which a metal section 1108 is in a heat storage state is prepared.

For example, if foods are hamburgs, about 80% to 90% of a cooking process is performed in a kitchen of the retail store 30. For example, at least processes of forming a hamburg dough and baking a first surface and a second surface of the formed hamburg dough are performed in a kitchen of the retail store 30. A hamburg is moved in the container body 1104 having the metal section 1108 in a heat storage state at a stage of perming a final heating step of baking a first surface again after baking the first surface and a second surface or at a stage leaving a partial final heating process. After moving a hamburg, the container body 1104 is closed with the lid 1102 and the food container 1100 is loaded on the transport vehicle 50. During the delivery of the food container 1100 with a transport vehicle 50, at least a part of a final heating step of a hamburg in a container body 1104 is performed.

As described above, if foods whose heating and cooking are uncompleted are placed in the container body 1104, the foods are heated and cooked by heat accumulated in the metal section 1108. A retail store server 32 may control a heater 1150 and adjust the amount of heat accumulated in a metal section 1108 based on an estimated time of arrival at a delivery destination. Depending on a food container 1100, foods close to a freshly cooked state can be provided to a customer at the time of delivery.

The cooking device 40 in the system 10 and the cooking device 940 and the food container 1100 in the system 900 described above can heat and cook foods 44 during the delivery, and thus, foods 44 close to a freshly cooked state can be provided to a customer at the time of delivery.

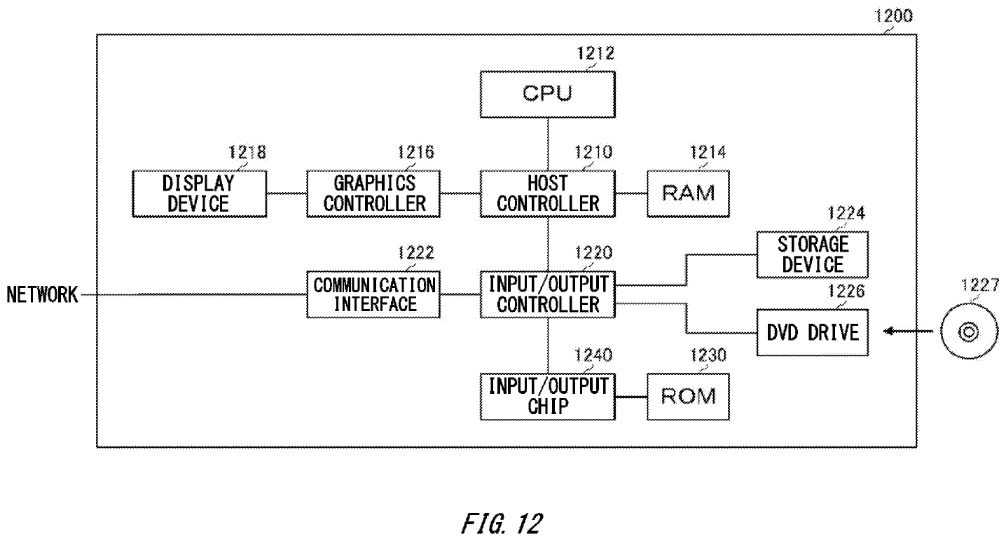

FIG. 12 schematically illustrates one example of a hardware configuration of a computer 1200 functioning as a control device 200 or a server 902. A program that is installed in the computer 1200 can cause the computer 1200 to function as one or more “units” of apparatuses of the above embodiments or perform operations associated with the apparatuses of the above embodiments or the one or more “units”, and/or cause the computer 1200 to perform processes of the above embodiments or steps thereof. Such a program may be executed by the CPU 1212 to cause the computer 1200 to perform certain operations associated with some or all of the blocks of flowcharts and block diagrams described in the specification.

The computer 1200 according to the present embodiment includes a CPU 1212, a RAM 1214, and a graphics controller 1216, which are mutually connected by a host controller 1210. The computer 1200 also includes input/output units such as a communication interface 1222, a storage device 1224, a DVD drive 1226 and an IC card drive, which are connected to the host controller 1210 via an input/output controller 1220. The DVD drive 1226 may be a DVD-ROM drive, a DVD-RAM drive, etc The storage device 1224 may be a hard disk drive, a solid-state drive, etc. The computer 1200 also includes legacy input/output units such as a ROM 1230 and a keyboard, which are connected to the input/output controller 1220 through an input/output chip 1240.

The CPU 1212 operates according to programs stored in the ROM 1230 and the RAM 1214, thereby controlling each unit. The graphics controller 2216 obtains image data generated by the CPU 2212 on a frame buffer or the like provided in the RAM 1214 or in itself, and causes the image data to be displayed on the display device 1218.

The communication interface 1222 communicates with other electronic device via network. The storage device 1224 stores programs and data used by the CPU 1212 within the computer 1200. The DVD drive 1226 reads the programs or the data from the DVD-ROM 1227 or the like, and provides the storage device 1224 with the programs or the data. The IC card drive reads programs and data from the IC card, and/or writes programs and data into the IC card.

The ROM 1230 stores therein a boot program or the like executed by the computer 1200 at the time of activation, and/or a program depending on the hardware of the computer 1200. The input/output chip 1240 may connect various input/output units to the input/output controller 1220 via a USB port, a parallel port, a serial port, a keyboard port, a mouse port, and the like.

A program is provided by computer readable storage media such as the DVD-ROM 1227 or the IC card. The program is read from the computer readable storage media, installed into the storage device 1224, RAM 1214, or ROM 1230, which are also examples of computer readable storage media, and executed by the CPU 1212. The information processing described in these programs is read into the computer 1200, resulting in cooperation between a program and the above-mentioned various types of hardware resources. An apparatus or method may be constituted by realizing the operation or processing of information, according to the usage of the computer 1200.

For example, when communication is performed between the computer 1200 and an external device, the CPU 1212 may execute a communication program loaded onto the RAM 1214 to instruct communication processing to the communication interface 1222, based on the processing described in the communication program. The communication interface 1222, under control of the CPU 1212, reads transmission data stored on a transmission buffer region provided in a recording medium such as the RAM 1214, the storage device 1224, the DVD-ROM 1227, or the IC card, and transmits the read transmission data to a network or writes reception data received from a network to a reception buffer region or the like provided on the recording medium.

In addition, the CPU 1212 may cause all or a necessary portion of a file or a database to be read into the RAM 1214, the file or the database having been stored in an external recording medium such as the storage device 1224, the DVD drive 1226 (DVD-ROM 1227), the IC card, etc., and perform various types of processing on the data on the RAM 1214. The CPU 1212 may then write back the processed data to the external recording medium.

Various types of information, such as various types of programs, data, tables, and databases, may be stored in the recording medium to undergo information processing. The CPU 1212 may perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 may search for information in a file, a database, etc., in the recording medium. For example, when a plurality of entries, each having an attribute value of a first attribute associated with an attribute value of a second attribute, are stored in the recording medium, the CPU 1212 may search for an entry matching the condition whose attribute value of the first attribute is designated, from among the plurality of entries, and read the attribute value of the second attribute stored in the entry, thereby obtaining the attribute value of the second attribute associated with the first attribute satisfying the predetermined condition.

The above-explained program or software modules may be stored in the computer readable storage media on or near the computer 1200. In addition, a recording medium such as a hard disk or a RAM provided in a server system connected to a dedicated communication network or the Internet can be used as the computer readable storage media, thereby providing the program to the computer 1200 via the network.

The blocks in the flowcharts and the block diagrams of the present embodiment may represent steps of processes for performing operations and “units” of devices having roles of performing operations. Certain steps and “units” may be implemented by dedicated circuit, programmable circuit supplied with computer-readable instructions stored on computer-readable storage media, and/or processors supplied with computer-readable instructions stored on computer-readable storage media. Dedicated circuits may include digital and/or analog hardware circuits and may include integrated circuits (IC) and/or discrete circuits. For example, the programmable circuit may include a reconfigurable hardware circuit such as a field-programmable gate array (FPGA), a programmable logic array (PLA), or the like including AND, OR, XOR, NAND, NOR, and other logical operation, a flip-flop, a register, and a memory element.

Computer-readable media may include any tangible device that can store instructions for execution by a suitable device, such that the computer-readable medium having instructions stored therein comprises an article of manufacture including instructions which can be executed to create means for performing operations specified in the flowcharts or block diagrams. Examples of computer-readable storage media may include an electronic storage medium, a magnetic storage medium, an optical storage medium, an electromagnetic storage medium, a semiconductor storage medium, etc. More specific examples of computer-readable media may include a floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, etc.

Computer-readable instructions may include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, JAVA (registered trademark), C++, etc., and conventional procedural programming languages, such as the “C” programming language or similar programming languages.

Computer-readable instructions may be provided to a processor of a general purpose computer, special purpose computer, or other programmable data processing apparatus, or to programmable circuitry, locally or via a local area network (LAN), wide area network (WAN) such as the Internet, etc., so that the processor of the general purpose computer, special purpose computer, or other programmable data processing apparatus, or the programmable circuitry executes the computer-readable instructions to create means for performing operations specified in the flowcharts or block diagrams. Examples of processors include computer processors, processing units, microprocessors, digital signal processors, controllers, microcontrollers, etc.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, the specification, and drawings can be performed in any order as long as the order is not indicated by “prior to,” “before,” or the like and as long as the output from a previous process is not used in a later process. Even if the process flow is described using phrases such as “first” or “next” in the claims, the specification, and the drawings, it does not necessarily mean that the process must be performed in this order.

### EXPLANATION OF REFERENCES

10: system, 20: network: 50: transport vehicle, 52: delivery box: 60: delivery destination: 30: retail store: 32: retail store server, 40: cooking device, 42: gap, 44: food, 46: food container, 200: control device, 205: heating apparatus, 210: heating device, 220: vapor generating device, 230: cooking device, 240: heating cooker, 221: heat transfer unit, 222: water retaining body, 223: vapor transmission plate, 232: second region, 300: control unit, 310: first heating unit, 320: second heating unit, 231: first region, 330: heating element, 340: acquiring unit, 350: position acquiring unit, 360: storage unit, 370: battery, 372: power cable connection port, 380: adjusting unit, 900: system, 1010: control device, 1020: heating control unit, 1040: communication unit, 1100: food container, 1102: lid, 1104: container body, 1106: bottom, 1150: heater, 1152: heater, 1200: computer, 1210: host controller, 1212: CPU, 1214: RAM, 1216: graphics controller, 1218: display device, 1220: input/output controller, 1222: communication interface, 1224: storage device, 1226: DVD drive, 1227: DVD-ROM, 1230: ROM, 1240: input/output chip

What is claimed is:

1. A system for controlling a heating cooker that cooks a food by heating the food, the system comprising:
an acquiring unit that acquires an estimated time of arrival at a delivery destination of the food during a delivery of the food; and
a control unit that controls the heating cooker based on the estimated time of arrival.

2. The system according to claim 1, wherein
the control unit determines a timing at which the heating cooker heats the food based on the estimated time of arrival.

3. The system according to claim 1, wherein
the control unit starts the heating by the heating cooker when a time between the estimated time of arrival and a current time is less than a predetermined time.

4. The system according to claim 1, wherein
the control unit controls the heating cooker based on a type of the food.

5. The system according to claim 1, further comprising:
a time information storage unit that stores information indicating a heating time associated with a type of a food, wherein
the control unit controls a timing at which the heating cooker heats the food based on the heating time associated with the type of the food and the estimated time of arrival.

6. The system according to claim 5, wherein
the control unit determines a timing at which the heating cooker heats the food based on the heating time associated with the type of the food, the estimated time of arrival, and a current time.

7. The system according to claim 1, wherein
the control unit adjusts a heating intensity of the food by the heating cooker based on the estimated time of arrival.

8. The system according to claim 7, wherein
the control unit adjusts the heating intensity of the food by the heating cooker based on a type of the food.

9. The system according to claim 7, further comprising:
an intensity information storage unit that stores heating intensity information indicating a time change in the heating intensity until cooking of the food is completed associated with a type of the food, wherein
the control unit controls a timing at which the heating cooker heats the food according to the heating intensity information based on the estimated time of arrival and a current time.

10. The system according to claim 1, wherein
the control unit acquires the estimated time of arrival at a plurality of timings and adjusts the heating intensity of the food by the heating cooker depending on a change in the estimated time of arrival.

11. The system according to claim 1, wherein
the control unit decreases the heating intensity of the food by the heating cooker when an arrival time at the delivery destination is predicted to be delayed from the estimated time of arrival after start heating the food by the heating cooker based on the estimated time of arrival.

12. The system according to claim 1, wherein
the control unit increases the heating intensity of the food by the heating cooker when an arrival time at the delivery destination is predicted to be earlier than the estimated time of arrival after start heating the food by the heating cooker based on the estimated time of arrival.

13. The system according to claim 1, further comprising:
a progress information storage unit that stores a degree of progress of cooking of the food when leaving for a delivery of the food, wherein
the control unit determines a timing at which the heating cooker heats the food based on the degree of progress and the estimated time of arrival.

14. The system according to claim 13, wherein
as the degree of progress is lower, the control unit increases a time between the estimated time of arrival and a timing at which the heating cooker heats the food.

15. The system according to claim 1, wherein
the heating cooker includes:
a first heating unit that heats a first region; and
a second heating unit that heats a second region;
the acquiring unit acquires a first estimated time of arrival at a delivery destination of a first food placed in the first region and a second estimated time of arrival at a delivery destination of a second food placed in the second region; and
the control unit controls the first heating unit based on the first estimated time of arrival and controls the second heating unit based on the second estimated time of arrival.

16. The system according to claim 1, wherein
the heating cooker includes:
a porous water retaining body;
a heating element that consumes power and heats the water retaining body; and
a cooking unit that contains the food and heats the food with water vapor from the water retaining body; and
the control unit controls the heating cooker by controlling a power amount to the heating element.

17. The system according to claim 1, further comprising the heating cooker.

18. A non-transitory computer readable storage medium having recorded thereon a program that causes the computer to perform operations comprising:
acquiring an estimated time of arrival at a delivery destination of the food during a delivery of the food; and
controlling a heating cooker that cooks the food by heating the food based on the estimated time of arrival

19. A method performed by a computer, the method comprising:
acquiring an estimated time of arrival at a delivery destination of a food during a delivery of the food; and
controlling a heating cooker that cooks the food by heating the food based on the estimated time of arrival.
